(19) United States
(12) Patent Application Publication
(10) Pub. No.: US 2010/0177005 A1
(43) Pub. Date: Jul. 15, 2010

(54) Multi-Band Antenna

(75) Inventors: Lan-Yung Hsiao, Taipei Hsien (TW); Pei-Fen Wu, Taipei Hsien (TW); Yu-Yuan Wu, Taipei Hsien (TW)

Correspondence Address: WPAT, PC;INTELLECTUAL PROPERTY ATTORNEYS, 2030 MAIN STREET, SUITE 1300, IRVINE, CA, 92614, US

(73) Assignee: CHENG UEI PRECISION INDUSTRY CO., LTD., Taipei Hsien (TW)

(21) Appl. No.: 12/354,705

(22) Filed: Jan. 15, 2009

(51) Int. Cl. H01Q 1/38; H01Q 1/48

(52) U.S. Cl. 343/845; 343/700 MS

(57) ABSTRACT

A multi-band antenna includes a first radiating portion, a second radiating portion extending perpendicularly from the first radiating portion, a third radiating portion extending perpendicularly from the second radiating portion and located at a same side concerning the second radiating portion with the first radiating portion, a fourth radiating portion extending perpendicularly from the third radiating portion and located at a same side concerning the third radiating portion with the second radiating portion, a fifth radiating portion extending from the fourth radiating portion towards the second radiating portion and spaced from the second radiating portion, a sixth radiating portion aligned with the first radiating portion with a feeding portion connected therebetween, a seventh radiating portion extending towards the fourth radiating portion from the sixth radiating portion, and a grounding portion spaced from the first radiating portion and the sixth radiating portion and having a grounding point.

### BACKGROUND OF THE INVENTION

1. Field of the Invention

The invention relates to a multi-band antenna, and particularly to a multi-band antenna mounted in a mobile communication device capable of covering multiple frequency bands.

2. The Related Art

In recent years, wireless data transmission technology is applied widely in many fields, not only in audio information transmission, but also for video surveillance information transmission. Nowadays, the communication systems widely used in the world mainly include global system for mobile communication 850 (GSM850), GSM900, digital cellular system 1800 (DCS1800), personal communication system 1900 (PCS1900) and wideband code division multiple access 2100 (WCDMA2100).

Accordingly, mobile communication devices for transmitting the wireless communication data need antennas designed correspondingly to transmit electromagnetic signals. However, a conventional antenna only covers two or three frequency bands of the communication systems mentioned above. As a result, the mobile communication devices equipped with the conventional antennas cannot be used in some districts. So it is necessary to design an antenna capable of covering the frequency bands mentioned synchronously.

### SUMMARY OF THE INVENTION

An object of the present invention is to provide a multi-band antenna applied in a mobile communication device and capable of covering multiple frequency bands.

The multi-band antenna etched on a printed circuit board has a first antenna radiator. The first antenna radiator includes a first radiating portion, a second radiating portion extending perpendicularly from a side of the first radiating portion, a third radiating portion extending perpendicularly from a free end of the second radiating portion and located at a same side with respect to the second radiating portion with the first radiating portion, a fourth radiating portion extending perpendicularly from an end of the third radiating portion and located at a same side with respect to the third radiating portion with the second radiating portion, and a fifth radiating portion extending from a side of the fourth radiating portion towards the second radiating portion and spaced away from the second radiating portion. A second antenna radiator includes a sixth radiating portion in alignment with the first radiating portion, and with a feeding portion connected between the first radiating portion and the sixth radiating portion, and a seventh radiating portion extending perpendicularly towards the fourth radiating portion from a side of the sixth radiating portion and spaced away from the fourth radiating portion. A grounding portion is spaced away from the first radiating portion and the sixth radiating portion, and has a grounding point disposed thereon adjacent to the feeding portion.

As described above, the multi-band antenna etched on the printed circuit board has a simple and compact structure, which is convenient to assemble and occupy a small space of the mobile communication device. Meanwhile, the first antenna radiator and the second antenna radiator are capable of covering frequency bands between 825 MHz and 960 MHz, and between 1710 MHz and 2170 MHz, which makes the multi-band antenna capable of receiving and sending electromagnetic signals of GSM825, GSM900, DCS1800, PCS1900 and WCDMA2100. So the multi-band antenna can cover multiple frequency bands mainly used in the world to meet use demands and be applied widely.

### BRIEF DESCRIPTION OF THE DRAWINGS

The present invention will be apparent to those skilled in the art by reading the following description of an embodiment thereof, with reference to the attached drawings, in which:

FIG. 1 is a plan view illustrating a structure of a multi-band antenna according to an embodiment of the present invention;

FIG. 2 is a Smith chart recording impedance of the multi-band antenna shown in FIG. 1; and

FIG. 3 shows a Voltage Standing Wave Ratio (VSWR) test chart of the multi-band antenna shown in FIG. 1.

### DETAILED DESCRIPTION OF THE PREFERRED EMBODIMENT

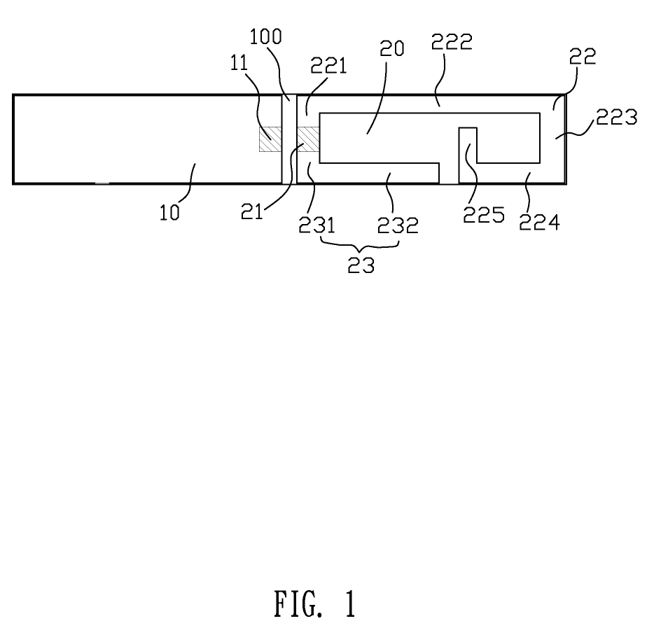

Please refer to FIG. 1, a multi-band antenna of an embodiment in according to the present invention is shown. The multi-band antenna may be etched in a basic board 100 made from a printed circuit board. The multi-band antenna has a grounding portion 10 and an antenna unit in alignment with the grounding portion 10 and spaced away from an end of the grounding portion 10 with a predetermined distance. The grounding portion 10 is substantially a rectangular shape and has a grounding point 11 disposed at a middle portion of an end thereof adjacent to the antenna unit.

The antenna unit has a first antenna radiator 22 and a second antenna radiator 23. The first antenna radiator 22 has a first radiating portion 221 extending upwards and downwards and spaced away from the grounding portion 10. An upper side of the first radiating portion 221 opposite to the grounding portion 10 is extended back to the grounding portion 10 to form a second radiating portion 222. The second radiating portion 222 is an elongated shape. A free end of the second radiating portion 222 is bent downwards and extended to form a third radiating portion 223 of strip shape. The third radiating portion 223 is parallel to the first radiating portion 221. A distal end of the third radiating portion 223 is extended perpendicularly towards the grounding portion 10 to form a fourth radiating portion 224 of strip shape. A distal end of the fourth radiating portion 224 is extended perpendicularly towards the second radiating portion 222 to form a fifth radiating portion 225, with a gap formed therebetween.

The second antenna radiator 23 has a sixth radiating portion 231 in alignment with the first radiating portion 221. A feeding portion 21 is connected between the first radiating portion 221 and the sixth radiating portion 231 and in alignment with the grounding point 11. Herein, the feeding portion 21 and the grounding point 11 are all coated with gold to show a rectangular shape. A lower side of the sixth radiating portion 231 opposite to the grounding portion 10 extends back to the grounding portion 10 to form a seventh radiating portion 232. The seventh radiating portion 232 is a strip shape, with a distal end thereof spaced away from the fifth radiating portion 225 to form a gap therebetween. In this embodiment, the antenna unit is substantially a rectangular-frame shape. Thereinto, a lengthways length of the grounding portion 10 is substantially equivalent to that of the antenna unit, and a width of the grounding portion 10 is substantially equivalent to that of the antenna unit.

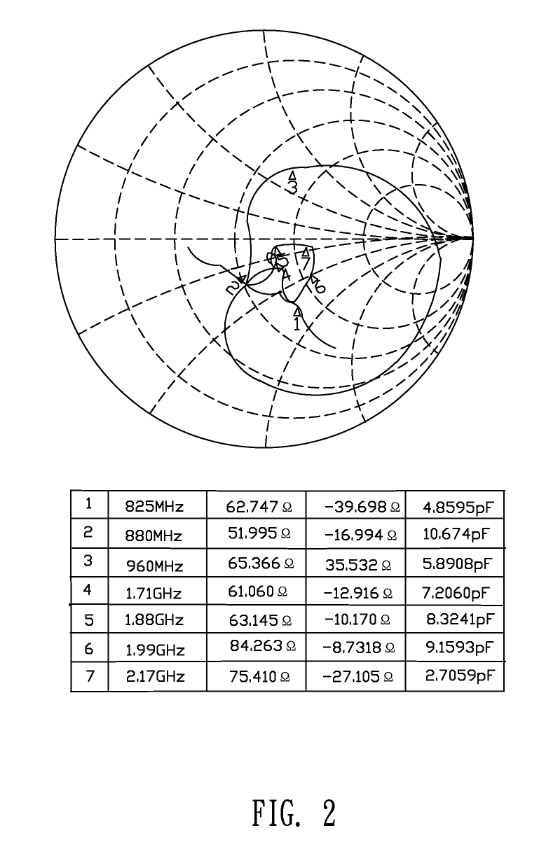

Please refer to FIG. 2, which shows a Smith chart recording impedance of the multi-band antenna in the embodiment when the multi-band antenna operates at wireless communication. The multi-band antenna exhibits an impedance of (62.747-j39.698) Ohm at 825 MHz, an impedance of (51.995-j16.994) Ohm at 880 MHz, an impedance of (65.366+j35.532) Ohm at 960 MHz, an impedance of (61.060-j12.916) Ohm at 1.71 GHz, an impedance of (63.145-j10.170) Ohm at 1.88 GHz, an impedance of (84.263-j8.7318) Ohm at 1.99 GHz and an impedance of (75.410-j27.105) Ohm at 2.17 GHz. Therefore, the multi-band antenna has good impedance characteristics.

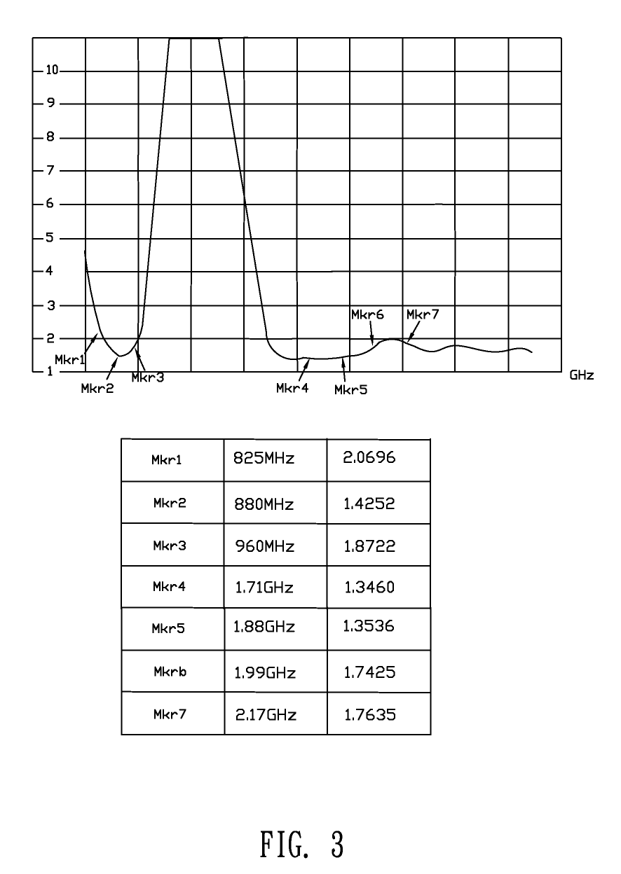

Please refer to FIG. 3, which shows a Voltage Standing Wave Ratio (VSWR) test chart of the multi-band antenna in the embodiment when the multi-band antenna operates at wireless communication. When the multi-band antenna operates at 825 MHz (indicator Mr1 in FIG. 3), the VSWR value is 2.0696. When the multi-band antenna operates at 880 MHz (indicator Mr2 in FIG. 3), the VSWR value is 1.4252. When the multi-band antenna operates at 960 MHz (indicator Mr3 in FIG. 3), the VSWR value is 1.8722. When the multi-band antenna operates at 1.71 GHz (indicator Mkr4 in FIG. 3), the VSWR value is 1.3460. When the multi-band antenna operates at 1.88 GHz (indicator Mkr5 in FIG. 3), the VSWR value is 1.3536. When the multi-band antenna operates at 1.99 GHz (indicator Mkr6 in FIG. 3), the VSWR value is 1.7425. When the multi-band antenna operates at 2.17 GHz (indicator Mkr7 in FIG. 3), the VSWR value is 1.7635. The VSWR value of the multi-band antenna shows that the multi-band antenna has an excellent frequency response between 825 MHz˜960 MHz and between 1.71 GHz˜2.17 GHz.

When the multi-band antenna operates at wireless communication, a current is fed from the feeding portion 21 to the first antenna radiator 22 to generate an electrical resonance of a frequency band ranging from 825 MHz to 960 MHz for receiving and sending electromagnetic signals of GSM 825 and GSM900. While the current is fed from the feeding portion 21 to the second antenna radiator 23 to generate an electrical resonance of a frequency band ranging from 1710 MHz to 2170 MHz for receiving and sending electromagnetic signals of DCS 1800, PCS 1900 and WCDMA 2100.

As described above, the multi-band antenna is formed at the basic plate 100, which is convenient to assemble and occupies a small space of the mobile communication device. Meanwhile, the first antenna radiator 22 and the second antenna radiator 23 are capable of covering frequency bands between 825 MHz and 960 MHz, and between 1710 MHz and 2170 MHz, which makes the multi-band antenna capable of receiving and sending electromagnetic signals in GSM825, GSM900, DCS1800, PCS1900 and WCDMA2100. So the multi-band antenna can cover multiple frequency bands mainly used in the world and be applied widely.

Furthermore, the present invention is not limited to the embodiment described above; various additions, alterations and the like may be made within the scope of the present invention by a person skilled in the art. For example, respective embodiments may be appropriately combined.

What is claimed is:

1. A multi-band antenna etched on a printed circuit board, comprising:
a first antenna radiator, the first antenna radiator including a first radiating portion, a second radiating portion extending perpendicularly from a side of the first radiating portion, a third radiating portion extending perpendicularly from a free end of the second radiating portion and located at a same side with respect to the second radiating portion as the first radiating portion, a fourth radiating portion extending perpendicularly from a free end of the third radiating portion and located at a same side with respect to the third radiating portion as the second radiating portion, and a fifth radiating portion extending perpendicularly towards the second radiating portion and spaced away from the second radiating portion from a free end of the fourth radiating portion;
a second antenna radiator, the second antenna radiator including a sixth radiating portion in alignment with the first radiating portion, and a seventh radiating portion extending perpendicularly towards the fourth radiating portion from a side of the sixth radiating portion and spaced away from the fourth radiating portion;
a feeding portion connected between the first radiating portion and the sixth radiating portion; and
a grounding portion spaced away from the first radiating portion, the feeding portion and the sixth radiating portion, and having a grounding point disposed thereon adjacent to the feeding portion.

2. The multi-band antenna as claimed in claim 1, wherein the grounding portion is a substantially rectangular shape, the grounding point is arranged at a middle portion of an end thereof adjacent to the feeding portion.

3. The multi-band antenna as claimed in claim 2, wherein the first antenna radiator and the second antenna radiator form cooperatively an antenna unit of substantially rectangular shape, the dimension of the grounding portion is substantially equivalent to that of the antenna unit.

4. The multi-band antenna as claimed in claim 1, wherein the fourth radiating portion is aligned with the seventh radiating portion.
